(19) United States
(12) Patent Application Publication
(10) Pub. No.: US 2001/0055013 A1
(43) Pub. Date: Dec. 27, 2001

(54) Three-dimensional modeling system having parametric function and parameter editing method according to same

(76) Inventor: Naoki Fuki, Okazaki-city (JP)

Correspondence Address: Larry S. Nixon, Esq., NIXON & VANDERHYE P.C., 8th Floor, 1100 North Glebe Rd., Arlington, VA, 22201-4714, US

(21) Appl. No.: 09/858,636

(22) Filed: May 17, 2001

(30) Foreign Application Priority Data
Jun. 16, 2000 (JP) 2000-181044

(51) Int. Cl. G06T 15/00

(52) U.S. Cl. 345/419

(57) ABSTRACT

To edit parameter items freely to improve the conveniences in a three-dimensional model design, a three-dimensional model is read from a server, and there are displayed (at Steps 101 to 103) on that three-dimensional model the parameter information (i.e., items of the parameters and their data) which belong to the model or components selected to be edited. After this, the parameter items are deleted (at Step 108) wholly or partially. Moreover, the parameter list in the server is displayed, and the parameter items necessary at this time are selected from the list. After this, the editions of the parameter items are executed (at Steps 109 to 112). In other words, on the various parameter information, there are newly added the items to be needed at this time. After this, the items of the parameters added at this time are registered in the server (at Steps 113 and 114), if they are not registered yet in the server.

### CROSS REFERENCE TO RELATED APPLICATION

This application is based upon and claims the benefit of priority of Japanese Patent Application No. 2000-181044 filed on Jun. 16, 2000, the content of which is incorporated herein by reference.

### BACKGROUND OF THE INVENTION

1. Field of the Invention

The present invention relates to a function to edit a variety of parameter information in a computer-aided three-dimensional modeling system.

2. Description of Related Art

In recent years, the CAD system is in a transition of conversion from a two-dimensional drawing to a three-dimensional model. In the three-dimensional CAD at the first time, the three-dimensional model has stereoscopic shape information, when made, but does not have the parameter information of the individual elements forming the stereoscopic shape. Where the shape of the three-dimensional model is to be changed because of a design change, therefore, the designer is compelled to perform considerably troublesome works by making the three-dimensional model again from the first. In view of this actual practice, the CAD system has been advanced to have the parameter information of the individual elements composing the stereoscopic shape. When the three-dimensional model is to be changed in shape, therefore, even the made-up model can be easily changed by changing the values of the element parameters. Here, this function is generally called the “parametric function”.

FIG. 9 is a diagram simply showing the flow of steps relating to the design of a three-dimensional model. For example, a three-dimensional model is designed in an own CAD system. In this design, there are suitably added the parameter information (e.g.,items of various parameters and corresponding data). After this, the three-dimensional model is used at an after step such as at the time of a design change or a mold model design, and the numerical data are changed, if necessary, by the parametric function to change the model shape. Here, the graphic information of the three-dimensional model are made into database and are stored in a server SA.

In the construction in which the own CAD system and another CAD system are connected by communication means such as the internet so that the data can be exchanged (or transferred), on the other hand, the graphic information of the three-dimensional model are transmitted from the own company to another.

Although the CAD system has been functionally improved, however, it is the current practice that the following problems have risen.

(1) Problem at Design Change

For making one stereoscopic shape, there are several methods. If a cylinder is considered, there are a method of making the cylinder by forming a circle at first for the bottom face and by sweeping the circle to a height, and a method of making the cylinder by forming a rectangle having one half width of the section and by turning the rectangle on a center axis. Even for this simple shape, the making methods are various, and the actual products have a number of kinds of shapes. Thus, there are a number of various parameter information on the three-dimensional model. Where the shape made by a method is to be changed, there may be no information on the parameters to be changed. In this case, there arises a problem that the product has to be made in the changed shape from the first time.

(2) Problem at After Step

For exploiting the model made by the three-dimensional CAD, it is important that the parameters are coupled to the model. When a mold model is to be manufactured from a design model, for example, it can be simply designed by controlling the parameters if there are added in advance the manufacture requisites such as the shrinkage of a resin or a parting slope.

However, it is thought in most cases to have failed to investigate the design sufficiently because of restrictions on the delivery time and the cost, and whether or not the designer makes a design under a complete understanding of the after step is questionable. It cannot be helped that the beginner has no understanding of the after step. Where the design model sent to the after step lacks for the parameter information, therefore, there arises a problem that a shape once made is deleted at the after step and a shape having newly controllable parameters has to be remade.

(3) Problem of Data Transfer

When the CAD data are transferred between companies or in a company, the receiver does not always need the parameter information but needs only the shape data. On the other hand, the model, as coupled to the parameter information, has a large amount of data to raise a problem that the data transfer takes a time.

(4) Problem of Data Compatibility

Several three-dimensional CAD systems have been produced from makers, but their world standards on the three dimensions are not fixed yet so that the individual CAD makers are still manufacturing the systems of their individual types. Therefore, no compatibility prevails between the data, and the current stage is that the model made by a CAD system cannot be read by another CAD system. In most cases, the model is converted into several types of data as the intermediate ones. Where the model is thus converted into the intermediate data, the coupling of the parameters is broken to raise a problem that the three-dimensional CAD data cannot be effectively exploited.

### SUMMARY OF THE INVENTION

The present invention has been conceived in view of the aforementioned problems and has an object to provide both a three-dimensional modeling system having the parametric function capable of editing parameter items freely thereby to improve the conveniences in the three-dimensional model design, a parameter editing method using the same system and a memory media incorporating a computer program for carrying out the parameter editing method.

To achieve the above object, the three-dimensional modeling system of the invention is realized by a computer-aided system such as the CAD or CAE and is premised by having a parametric function enabled to change the shape of a three-dimensional model by changing the data of a variety of parameters. Here, the parameter information are defined to be composed of items of parameters and data of the individual items.

Moreover, the invention is characterized in that a computer portion makes it possible to edit both the items of parameters belonging to a three-dimensional model and the data. In this case, in addition of the parametric function (to edit the parameter data) existing in the prior art, it is possible to perform “Editions of Parameter Items”, e.g., to change, delete and add the items of parameters newly. At the time of the design change or at the after step of making the mold model from the design model, therefore, the designing efficiency is improved by editing the parameter items. At this time, there does not arise a disadvantage that the changed shape has to be remade from the first, even where there is no parameter item to be controlled. Moreover, the items of the parameters can be narrowed, if necessary, to lighten the amount of data belonging to the three-dimensional model. As a result, the parameter items can be freely edited to improve the convenience in the three-dimensional model design.

In the three-dimensional modeling system, on the other hand, a computer portion makes it possible to delete the individual items of the parameters belonging to the three-dimensional model wholly or partially and then to add the items of the parameters, as needed at this time, newly and selectively. In this system, the parameter items can be freely edited to improve the convenience in the three-dimensional model design. Specifically, at the after step of changing the design or making the mold model from the design model, it is possible to perform the editions to change, delete and add the items of the parameters. Moreover, the items of the parameters can be narrowed, if necessary, to lighten the amount of data belonging to the three-dimensional model.

In the three-dimensional modeling system mentioned above, preferably, the computer portion is operative to make intermediate data of the three-dimensional model having no parameter information and then to add items of the parameters newly to the intermediate data. As a result, the graphic data can be read for the three-dimensional model which was designed by the incompatible system (i.e., the CAD system), thereby to make effective use of those data.

Further, in the aforementioned three-dimensional modeling system, when the three-dimensional model is outputted to computer terminals of different systems, the computer portion is operative to partly delete and narrow the items of the parameters, in accordance with the application of the three-dimensional model to be outputted or the specifications of the partner system, so that the output data can be prepared without any insufficiency. Specifically, the parameters may be narrowed according to causes for shape confirmations, for presentations or for design analyses.

Furthermore, in the three-dimensional modeling system, the computer portion makes it possible to add or delete the items of the parameters, as needed at this time, selectively from a parameter list registered in advance in a memory unit. In this case, the editions of the parameter items can be suitably executed by changing or adding the parameter items with reference to the parameter list.

Especially in the three-dimensional modeling system, the computer portion discriminates the items of the parameters, as needed at this time, automatically from the parameter list of the memory unit, and displays the list so that the designer may select the items of the parameters from the list, so that the parameter editing operations can be efficiently realized. In this case, for example, the items of the parameters may be automatically discriminated either by referring to the similar shapes or by learning from the past experiences of the parameter additions.

In the three-dimensional modeling system mentioned above, where the items of the parameters unregistered before in the parameter list are added, the items are newly registered in the parameter list of the memory unit. For example, it is thought that the items of the parameters relating to the design know-how are not registered from the beginning in the system but are often newly added by the individual designers. In this case, therefore, the new registration is made in the parameter list, as described above, so that the parameter list can be utilized for the subsequent parameter editions.

In the three-dimensional modeling system, the computer portion makes it possible to add parameters on a design know-how. In this case, by adding the design know-how, if necessary, as the parameter items, the graphic information grow wide, and their using values can rise to realize the practically excellent system.

In the three-dimensional modeling system, the computer portion is operative to once release the boundaries of the individual components of the three-dimensional model constituted by a plurality of components, then re-edits the three-dimensional model newly into a plurality of components in accordance with an instruction of the designer, and adds the items of the parameters to the new components. In this case, the boundaries (or editions) of the components set at first can be changed to change the design or to design the mold model freely and easily at the after step.

In the three-dimensional modeling system, the computer portion makes it possible to add the items of the parameters relating to a manufacture requisite, to the three-dimensional model. As a result, the desired parameter control can be made on the three-dimensional model which neither has considered the after step such as the mold model design nor has the parameters relating to the manufacture requisite.

As a method of editing the parameter or the computer program of the memory media for executing the method, preferably, the parameter editions are performed in a dialogue type between the three-dimensional modeling system and the designer. In summary, there are consecutively executed:

(1) a designer is caused to select a designed shape thereby to display the individual items of the parameters belonging to the designed shape;

(2) the individual items of the parameters, as displayed, are deleted wholly or partially; and

(3) after this, the items of the parameters, as needed at this time, are newly added by the selection of the designer.

The parameter items can be freely edited to improve the convenience in the three-dimensional model design. Specifically, at the after step of changing the design or making the mold model from the design model, it is possible to perform the editions to change, delete and add the items of the parameters. Moreover, the items of the parameters can be narrowed, if necessary, to lighten the amount of data belonging to the three-dimensional model.

In this case, at the time of adding the items of the parameters, a parameter list registered in advance in a memory unit may be displayed so that the designer may select the items of the parameters, as needed at this time, from the parameter list.

### BRIEF DESCRIPTION OF THE DRAWING

Other features and advantages of the present invention will be appreciated, as well as methods of operation and the function of the related parts, from a study of the following detailed description, the appended claims, and the drawings, all of which form a part of this application. In the drawings:

FIG. 1 is a block diagram showing a schematic construction of a three-dimensional CAD system according to an embodiment of the invention;

FIG. 2A is a diagram tabulating the detail of parameter information;

FIG. 2B is another diagram tabulating the detail of parameter information;

FIG. 3 is a flow chart showing a procedure of parameter editions;

FIG. 4A is a perspective view showing a three-dimensional model to be subjected to the parameter editions;

FIG. 4B is a perspective view showing the three-dimensional model as intermediate data;

FIG. 4C is a perspective view showing the three-dimensional model after parameter editions;

FIG. 4D is a perspective view showing the three-dimensional model after design change;

FIG. 5A is a diagram tabulating the parameter information belonging to the three-dimensional model of FIG. 4A;

FIG. 5B is a diagram tabulating the parameter information after having edited the parameter information of FIG. 5A;

FIG. 6A is a perspective view showing another three-dimensional model to be subjected to the parameter editions;

FIG. 6B is another perspective view showing the three-dimensional model of FIG. 6A;

FIG. 6C is a perspective view showing the three-dimensional model after design change;

FIG. 7A is top plan views of the three-dimensional model shown in FIG. 6A;

FIG. 7B is top plan views of the three-dimensional model shown in FIG. 6C;

FIG. 8A is a diagram tabulating the parameter information belonging to the three-dimensional model of FIG. 6;

FIG. 8B is a diagram tabulating the parameter information after having edited the parameter information of FIG. 8A; and

FIG. 9 is a diagram briefly showing a flow of steps relating to the design of a three-dimensional model.

### DETAILED DESCRIPTION OF THE PREFERRED EMBODIMENTS

Embodiments of the invention will be described with reference to the accompanying drawings. The three-dimensional CAD system has the so-called “parametric function” to define a three-dimensional model graphically with a variety of parameters, and this embodiment affords a function to edit the items and data of the parameters freely.

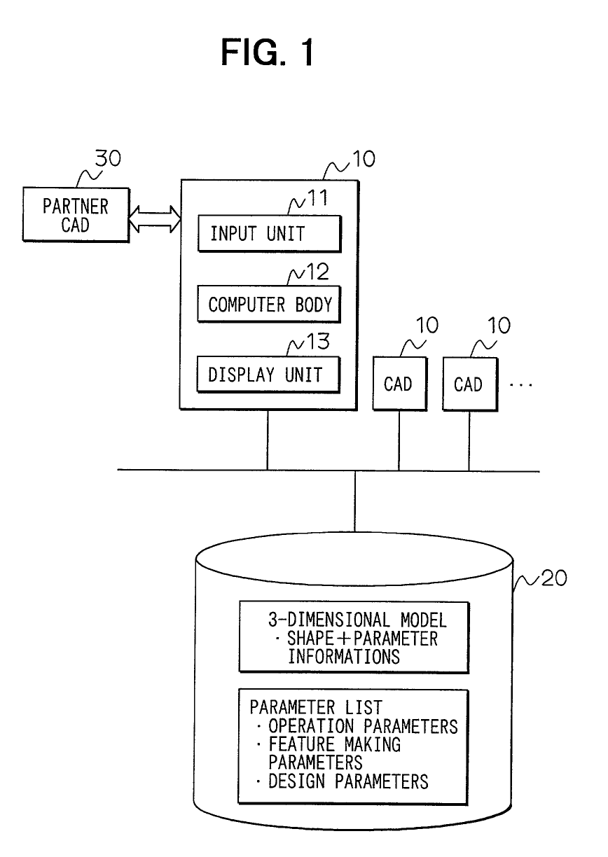

FIG. 1 is a block diagram showing a schematic construction of the present CAD system. In FIG. 1, a plurality of CAD devices (or computer terminals) 10 and a server 20 are so connected by network means such as the LAN as to communicate with each other. Any of the CAD devices 10 has a substantially identical construction, which is composed of an input unit 11 having a keyboard, a mouse and so on, a computer body (or computer unit) 12 forming the center of the present system, and a display unit 13. The computer body 12 is provided with a CPU, memories and so on, as well known in the art, and has a variety of functions for designing a three-dimensional model automatically. However, each CAD device 10 may not have a data compatibility.

The server 20 is stored with a database of various information on the three-dimensional model, and stores the shape information and parameter information in relation to each other on the three-dimensional model designed by the CAD device 10. When the three-dimensional model is read from the server 20, therefore, the shape information of the three-dimensional model are read out together with the various parameter information added to the former.

On the other hand, the CAD device 10 is connected through communication means such as the internet with a CAD device (or partner CAD device) 30 of another company, for example, so that it can read the three-dimensional model from the server 20 and transmit it to the partner CAD device 30.

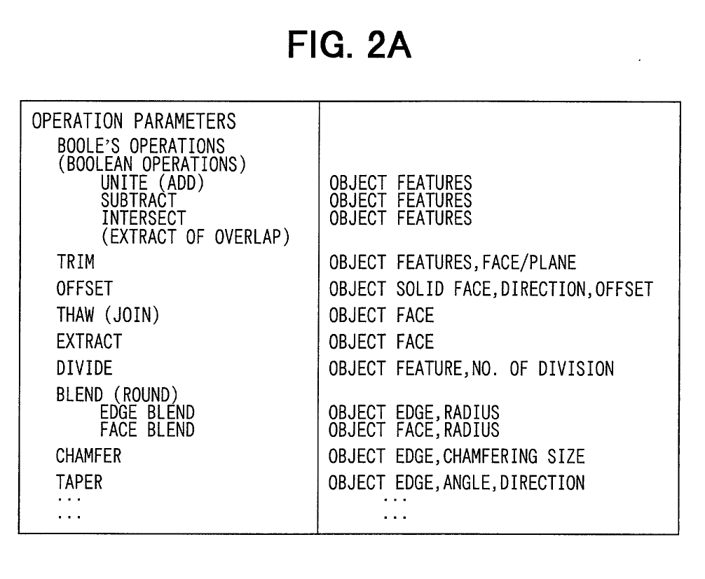

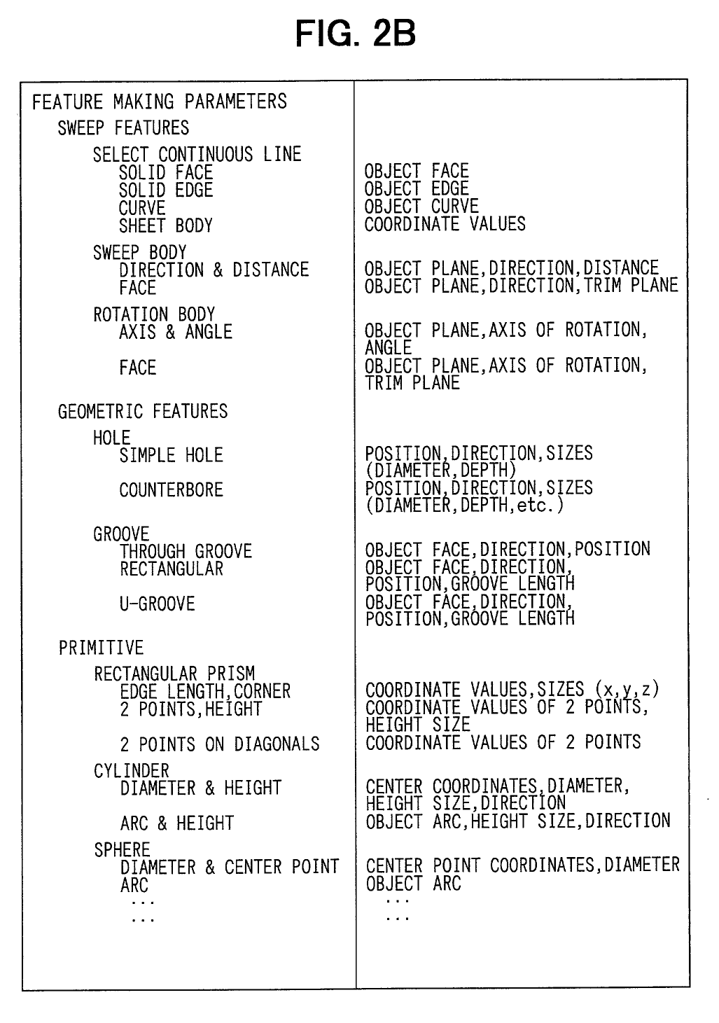

Here will be described the detail of the parameter information with reference to FIGS. 2A and 2B. FIGS. 2A and 2B enumerate one example of the parameter information, and the lefthand column tabulates the items of the parameters hierarchically whereas the righthand column tabulates the data corresponding to the items.

Operation Parameters shown in FIG. 2A and Feature Making Parameters shown in FIG. 2B are provided as the highest items of the parameter information. In the Operation Parameters, there are under the item of Boole's Operations (Boolean Operations) Unite (Add), Subtract and Intersect (Extract of Overlap). To the individual items, there are added Object features as data. In addition, there are shown parameter items (although not described).

In the Feature Making Parameters, on the other hand, there are lower items of Sweep Features, Geometric Features, and Primitive, under which there are hierarchically provided a plurality of items, as shown. Under the item of Sweep Features, there are items of Select Continuous Line, Sweep Body, Rotation Body and so on, under which there are provided items of Solid Face, Solid Edge, Curve, Sheet Body and so on, for example, under the item of Select Continuous Line. Moreover, the data are added to the lowermost parameter item.

However, FIGS. 2A and 2B exemplify the parameter items, and its contents should not be limited to the shown ones. In addition to the parameter items shown in FIGS. 2A and 2B, more specifically, it is arbitrary to provide: items of “Instance (Array), Threading or Scaling” as Operation Parameters; items of “Cylindrical Groove, Pocket” as Feature Making Parameters under Geometric Features; or items of “Conical, Tube” under Primitive.

The aforementioned individual items of the parameters are registered in advance as the parameter list in the server 20, so that a necessary item may be selected from the parameter list of the server 20 each time a new parameter item is added to the three-dimensional model.

On the other hand, the present CAD system is provided with not only the aforementioned “Operation Parameters” and “Feature Making Parameters” of FIG. 2 but also items of “Design Parameters”, as defined by the designer. Specifically, the items belonging to the design parameters are:

Design Know-How

Size Tolerances, Geometric Tolerances

Performances of Product

Material, Material Characteristics

Weight, Density

Manufacture Method, Working Method, Assembling Method

Surface Treatment, Heat Treatment, etc.

Surface Roughness

Cost, Quality Information, Failure Example.

These design parameter items are neither contained in the initial specifications of the CAD system nor registered in the parameter list of the server 20 but sequentially registered by the designer (or CAD operator) at the time of designing the three-dimensional model (or design change).

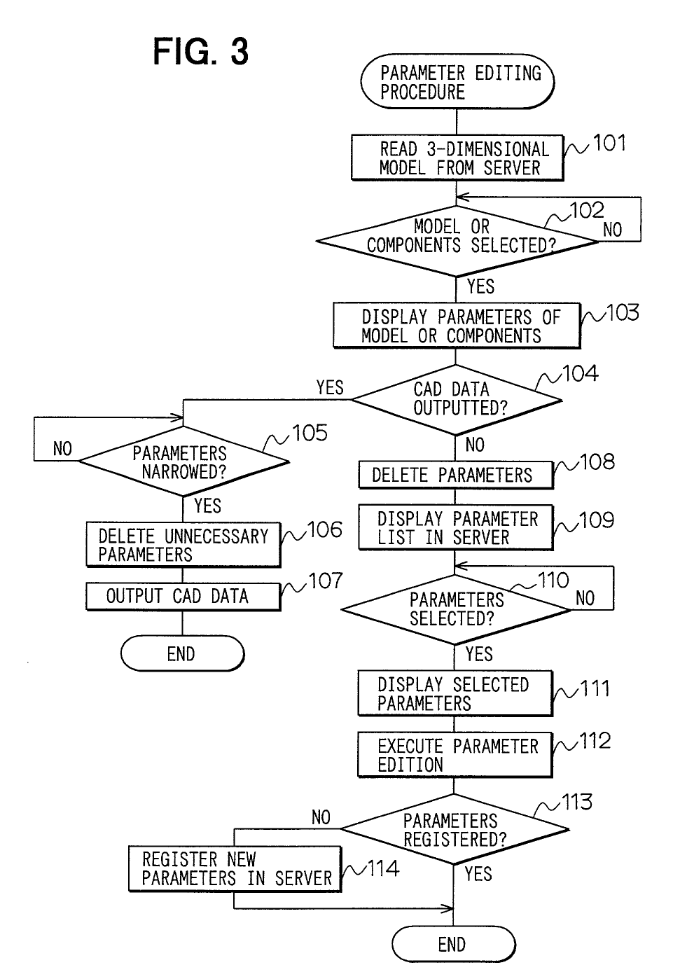

FIG. 3 is a flowchart showing the parameter editing procedure to be realized by the computer body 12. Here, the operations of FIG. 3 are executed at the times of the design change, the after step and the CAD data output to another company or the like, and the parameter editions are performed generally in a dialogue type between the CAD device 10 and the designer (or CAD operator).

At first Step 101, the three-dimensional model is read from the server 20. At subsequent Step 102, it is decided on the read three-dimensional model whether or not the model or components to be edited have been selected by the designer. If the model or components are selected, moreover, the routine advances to Step 103, at which the parameter information (i.e., items and data of the parameters) of the model or components selected are displayed in the display unit 13.

At Step 104, on the other hand, it is decided whether or not the CAD data are to be outputted to the computer terminal such as the partner CAD device 30 of another company. In the case of the CAD data output (that is, if the answer of Step 104 is YES), the parameter information of the CAD data are narrowed to the necessary minimum so that the partner CAD device 30 (or the reception side) can receive the data promptly.

At Step 105, specifically, it is decided whether or not the designer has narrowed the parameters by deleting the unnecessary parameters. If this answer is YES, the routine advances to Step 106. On narrowing the parameters, the designer may suitably select the items of the parameters to be attached to the CAD data, in dependence upon what the CAD data are to be outputted for, and narrows the parameters in accordance with the application such as for a shape confirmation, for a presentation or for a design analysis. Further, the parameters may be narrowed according to the specifications of the partner CAD device 30.

After this, at Step 106, the unnecessary parameters are deleted according to the instruction of the designer. At subsequent Step 107, the CAD data, from which the unnecessary parameters are deleted, are transmitted to the partner CAD device 30.

Not in the case of the CAD data output (that is, if the answer of Step 104 is NO), on the other hand, the routine advances to Step 108, at which the items of the parameters are deleted wholly or partially. At this time, the parameter items may be deleted all at once, but the parameter items may not be deleted but left as they are, if their parameter editions (e.g., deletions or changes) are known unnecessary.

After this, at Step 109, the parameter list in the server 20 is displayed in the display unit 13. At this time, the computer body 12 automatically discriminates such parameter items from the parameter list as are estimated to be necessary at this time, and displays their list. Specifically, for example, the items of the parameters are automatically discriminated either by referring to the similar shapes or by learning from the past experiences of the parameter additions.

At Step 110, moreover, it is decided whether or not the parameter items necessary at this time are selected by the designer. When the selection of the parameter items is ended, the routine advances to Step 111. At Step 111, moreover, the parameter items, as selected by the designer, are displayed in a list in the display unit 13.

After this, at Step 112, the edition of the parameter items is executed. To the various parameter information, specifically, there are newly added the items to become necessary at this time, together with the corresponding data. At this time, the designer may edit the parameters in view of the display screen of the display unit 13.

After this, at Step 113, it is decided whether or not the items of the parameters added at this time have already been registered in the server 20 (in the parameter list). If unregistered, moreover, the routine advances to Step 114, at which the items of the parameters are registered in the server 20 in accordance with the operation of the input unit 11 by the designer. For example, it is thought that the items of the parameters relating to the design know-how (i.e., the design parameters) are not registered from the beginning in the CAD system but are often newly added by the individual designers. In this case, the new registration is made in the parameter list, as described above, so that the parameter list can be utilized for the subsequent parameter editions. By registering the design parameters additionally, the more proper parameter items can be selected in the operation to discriminate the parameter items automatically at the foregoing Step 109. Here, a series of operations thus far described are repeatedly executed on all the models or components required for the parameter editions.

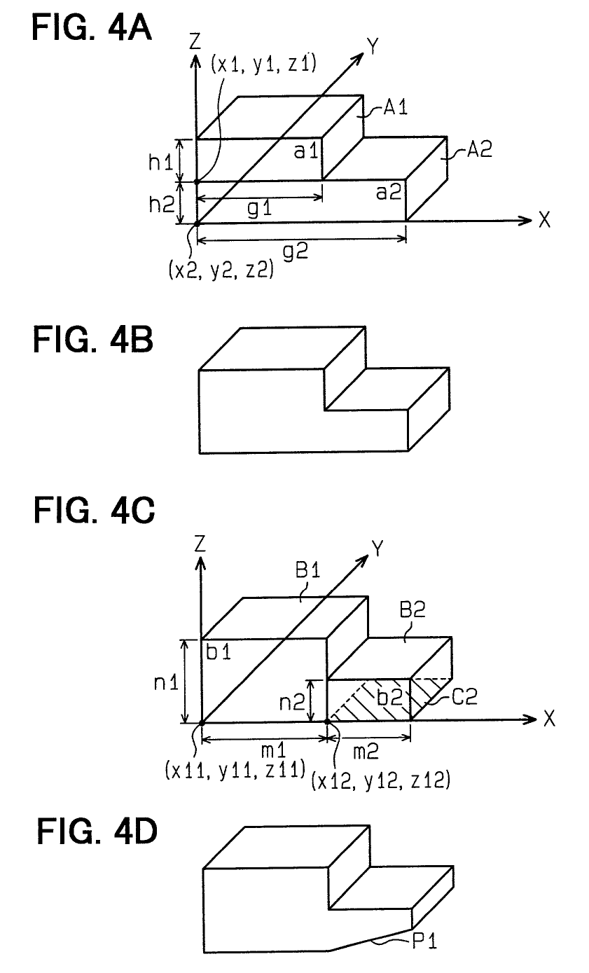

Here will be described a specific example of the parameter editions to be executed according to the operating procedure thus far described. FIG. 4A to 4D are perspective views showing a three-dimensional model to be subjected to the parameter editions. Of these, the three-dimensional model of FIG. 4A has not only the shape data but also the various parameter information, and corresponds to the three-dimensional model before edited. On the other hand, FIG. 4B shows the intermediate data which have deleted all the parameter information shown in FIG. 4A, and FIG. 4C shows the three-dimensional model after having been subjected to the parameter editions. FIG. 4D shows a three-dimensional model which is given a slope (as indicated at P1) by the design change or the like.

In FIG. 4A, the three-dimensional model to be edited at this time is constructed of a block shape having a step. This model is composed of sweep bodies A1 and A2 (of rectangular prisms) having flat planes a1 and a2 as individual reference planes and joined vertically of the Drawing. For the sweep bodies A1 and A2, respectively, there are set reference point coordinates (x1, y1, z1) and (x2, y2, z2), and sizes g1, h1, g2 and h2 relating to the flat planes a1 and a2.

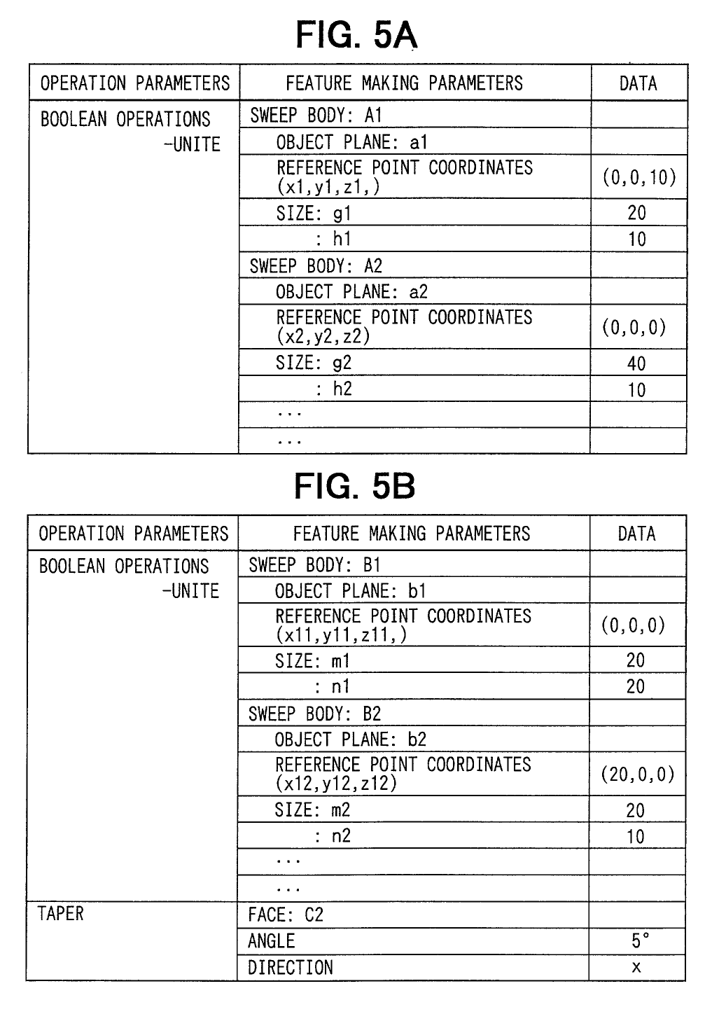

In this case, the parameter information belonging to the three-dimensional model of FIG. 4A are arranged to FIG. 5A. In FIG. 5A, specifically, the item of “Boolean Operations—Unite” is set as Operation Parameters. On the other hand, the item of “Sweep Bodies A1, A2” is set as Feature Making Parameters, under which “Object Planes a1, a2” is set, as shown. As the lowermost items of Feature Making Parameters, there are given the numeral data which individually correspond to them. Here in FIG. 5A, several parameter items are exemplified, but it goes without saying that there are other items.

For the three-dimensional model of FIG. 4A, let the case be considered, in which the leading end of the sweep body A2 is sloped by the design change or in which the leading end of the sweep body A2 is provided with a parting slope at the after step of the mold modeling design (as shown in FIG. 4D). In other words, let it be considered that the bottom face of the sweep body A2 is tapered. In this case, with the sweep bodies A1, A2 being left as the parameters, the design is difficult because of absence of the parameters for designating the gradient (or taper). Therefore, there are edited the items of not only the sweep bodies A1, A2 but also the various parameter items.

Here, the parameter information to be added, as shown in FIG. 4A, are modified into those of FIG. 4C. FIG. 4B shows the state, in which all the parameter items of the three-dimensional model are deleted, so that the shape information (or contour data) of the three-dimensional model are exclusively left.

The three-dimensional model, as shown in FIG. 4C, is composed of sweep bodies B1, B2 (of rectangular prisms) having flat faces b1, b2 as the individual reference faces and joined horizontally of the Drawing. For the sweep bodies B1, B2, respectively, there are set the reference point coordinates (x11, y11, z11) and (x12, y12, z12) and sizes m1, n1, m2, n2 on the flat planes b1, b2. It is further instructed that the face C2 of the sweep body B2 (i.e., the bottom face of B2) is tapered.

In the case of the three-dimensional model of FIG. 4C, the parameter items are newly added, as shown in FIG. 4C, to the intermediate data of FIG. 4B, so that the three-dimensional model has the parameter information tabulated in FIG. 5B. Here will be described the differences of FIG. 5B from FIG. 5A. As Feature Making Parameters, there are set items of “Sweep Body B1, B2”, under which there are set “Object Plane b1, b2”, as tabulated. On the other hand, there are newly set items “Face C2, Angle, Direction” on the taper.

In short, at the transfer from FIG. 4A to FIG. 4B, the boundaries of the individual components (A1, A2) are once released. After this, the three-dimensional model is newly re-edited into the plurality of components (B1, B2) in accordance with the instruction of the designer, and the items of the parameters are added to the new components.

In collation with the procedure (or the flow chart of FIG.

3) by the computer body 12, at Steps 101 to 103 of FIG. 3, the parameter items are extracted on the three-dimensional model of FIG. 4A and are displayed in the display unit 13. At this time, there is displayed the screen tabulated in FIG. 5A.

At Step 108 of FIG. 3, there are made the intermediate data of FIG. 4B. After this, at Step 112, the parameter items are edited, and the screen tabulated in FIG. 5B is displayed after the editions. By these series parameter editions, there are easily and properly made the design changes such as a change to slope the three-dimensional model partially.

When the parameter information are to be edited from those of FIG. 5A to FIG. 5B, the items on the sizes are changed from “Size g1, h1, g2, h2” to “Size m1, n1, m2, n2”, but the computer body 12 discriminates it automatically that the numerical data of the individual sizes are changed according to the changes in the aforementioned parameter information, and computes and writes the new numerical data by itself. However, the operation to change the numerical data of the individual sizes could be performed by the manual operation of the designer (or the CAD operator).

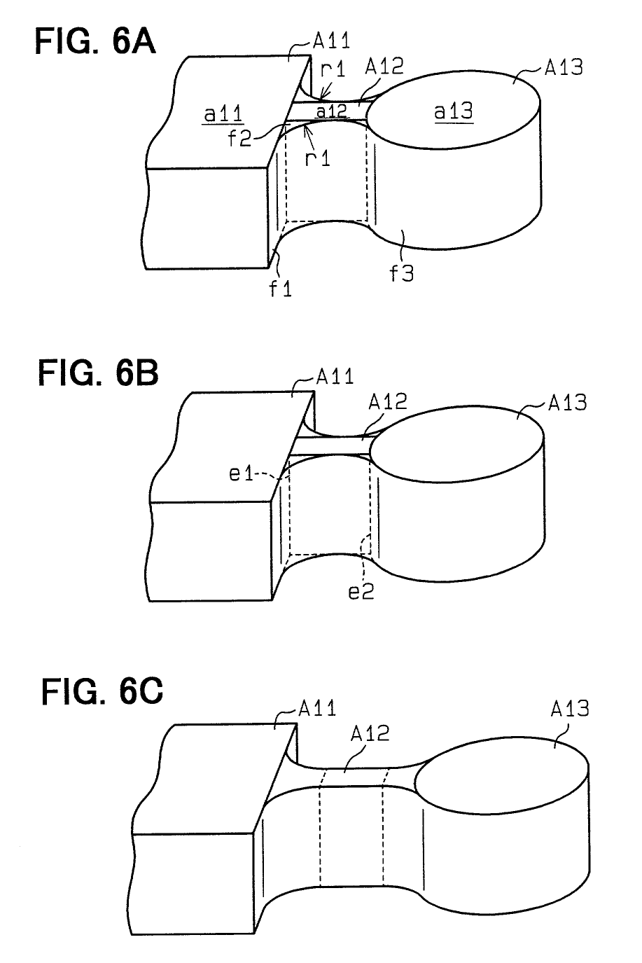

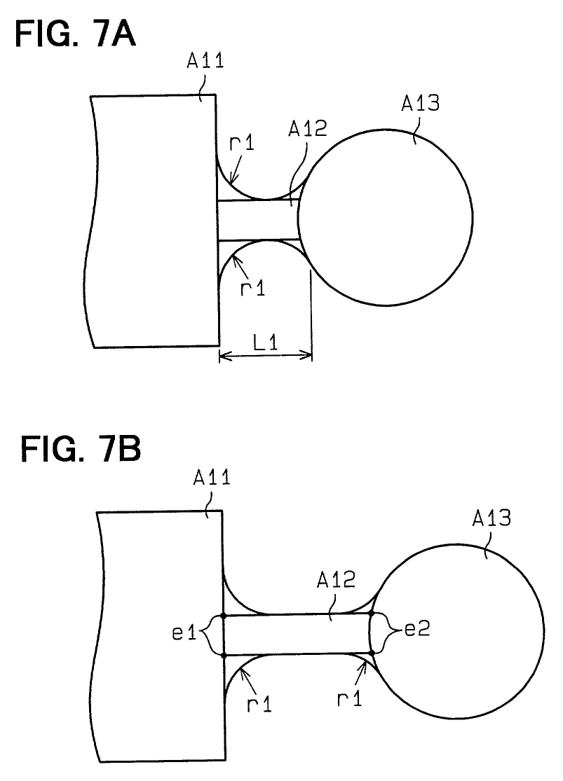

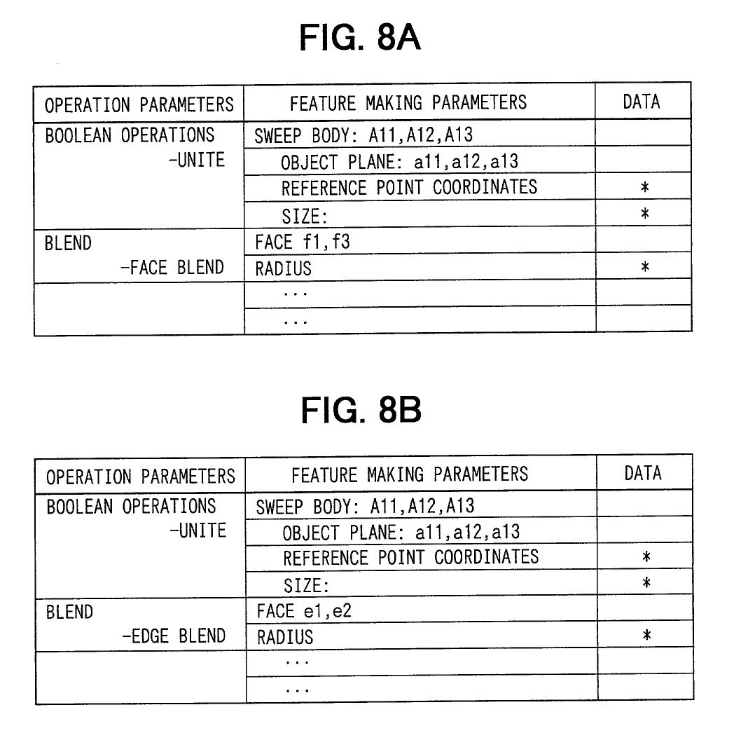

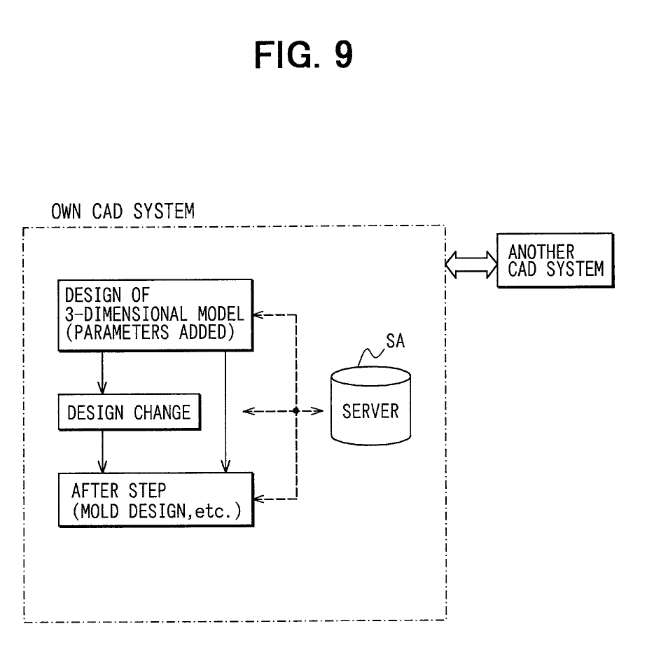

Another specific example will be described with reference to FIGS. 6 to 8. FIGS. 6A to 6C present perspective views showing a three-dimensional model to be subjected to the parameter editions, and FIGS. 7A and 7B present top plan views, as taken from above, of the three-dimensional model of FIGS. 6A and 6C. On the other hand, FIGS. 8A and 8B tabulate the parameter information belonging to the three-dimensional model of FIGS. 6A to 6C.

In FIG. 6A, the three-dimensional model to be edited at this time is constructed of sweep bodies A11, A12 and A13 having flat planes a11, a12 and a13 individually as reference planes and joined to one another. Moreover, the sweep bodies A11 and A13 are rounded with a corner R of a radius r1. In this construction, the length L1 in the distance (in FIG. 7A in fact) between the sweep bodies A11 and A13 is two times as long as the radius r1 (i.e., L1=2×r1), and the corner R contacts with all a face f1 of the sweep body A11, a face f2 of the sweep body A12 and a face f3 of the sweep body A13. Therefore, the item of “Blend —Face Blend” is set as that of Operation Parameters, and the item of “Face f1, f3” is set as that of Feature Making Parameters (as referred to FIG. 8A).

For the three-dimensional model of FIG. 6A, let the case be considered, in which the design change is made to FIG. 6C (or FIG. 7B) not by changing the radius r1 of the corner R but by extending the length (i.e., L1 of FIG. 7A) of the sweep body A12. In this case, the parameter items on the blend are changed, because the desired corner R cannot be added if the item of Operation Parameters is left as “Blend—Face Blend”.

In short, in the three-dimensional model shown in FIG. 6B, edges e1 and e2 of the model are designated, and the corner R of the radius r1 is added to the edges e1 and e2. In this case, the item of “Blend—Edge Blend” is set as that of Operation Parameters, and the item of “Edge e1, e2” is set as that of Feature Making Parameters (as referred to FIG. 8B).

By thus changing the parameter items, the design change to the three-dimensional model of FIG. 6C can be made merely by changing the numerical data on the length of the sweep body A12.

According to the present embodiment thus far described in detail, there can be achieved the following effects.

(1) The individual items of the parameters belonging to the three-dimensional model are deleted wholly or partially, and the items necessary at this time are selectively added. In this case, in addition of the parametric function (i.e., the editions of parameter data) existing in the prior art, it is possible to perform “Editions of Parameter Items”, e.g., to change, delete and add the items of parameters newly.

At the time of the design change or at the after step of making the mold model from the design model, therefore, the designing efficiency is improved by editing the parameter items. At this time, it is possible to solve the problem in which the changed shape has to be remade from the first, as might otherwise be caused by the absence of the parameter items to be controlled. Even to the three-dimensional model designed without understanding the after step, on the other hand, there can be suitably added the parameter items which have the additional manufacture requisites. Moreover, the items of the parameters can be narrowed, if necessary, to lighten the amount of data belonging to the three-dimensional model. As a result, it is possible to solve the problem in which the transfer of the CAD data takes a long time.

According to the present CAD system, as has been described hereinbefore, the parameter items can be freely edited to improve the conveniences in the three-dimensional model designs. To the three-dimensional model intrinsically having no parameter information, there can be added parameters to design and investigate the three-dimensional model.

(2) There is made the intermediate data of the three-dimensional model having no parameter information, and the items of parameters are newly added to those intermediate data. As a result, the graphic data can be read for the three-dimensional model which was designed by the incompatible CAD system, thereby to make effective use of those data.

(3) When the CAD data are to be outputted to the partner CAD device 30, the items of parameters to be deleted are narrowed according to the application of those data or the specifications of the partner CAD device 30, so that the output data can be prepared without any insufficiency.

(4) From the parameter list registered in advance in the server 20, the items of parameters, as needed at this time, are automatically discriminated, and their list is displayed. From this list, the designer is entrusted to select the parameter items so that the parameter editing operations can be efficiently realized.

(5) Where an unregistered parameter item is added to the parameter list, the item is newly registered in the parameter list of the server 20, so that the design parameters on the design know-how, for example, are sequentially registered and gradually stored. As a result, an effective auxiliary function can be given for realizing the so-called “automatic design”, in which the designing investigations of the three-dimensional model are automatically made in the CAD system. Where a mistaken design or a novel design is made, for example, it can be automatically decided by the CAD system to give some notice to the designer.

(6) “Design Parameters” on Design Know-How, Size Tolerances, Geometric Tolerances, Cost and Quality Information and Failure Examples are added. As the graphic information of the three-dimensional model grow the wider, therefore, their using values can rise the higher to realize the practically excellent CAD system.

In addition to the foregoing embodiment, the invention can be embodied in the following modes.

In the foregoing embodiment, at Step 109 of FIG. 3, the parameter items, as estimated to become necessary at this time, are automatically discriminated from the parameter list. In addition, it is arbitrary to refer to parameters from another file or model thereby to select the parameter items from the file or model.

In the ordinary CAD system, a three-dimensional model is made by making a sketch and then by sweeping or rotating planes or lines. According to the invention, however, the method or order of making the parameter information of the three-dimensional model is discriminated so that the sketch is made reversely from the made-up model.

In the foregoing embodiment, the three-dimensional modeling system has been constructed by using the system or software, as generally called the “CAD”. Otherwise, the three-dimensional modeling system may also be constructed by using the system or software, as called “CAE” or “CAM”.

What is claimed is

1. A three-dimensional modeling system having a computer portion enabling a parametric function to change a shape of a three-dimensional model by designer's changing parameter information belonging to the three-dimensional model, characterized in that:
the parameter information, which are composed of parameter items and data of the respective parameter items, are stored in the computer portion, wherein both the parameter items and the data are read out from the computer portion and are edited to change the parameter information by the designer.

2. A three-dimensional modeling system as set forth in claim 1, wherein the computer portion makes it possible for the designer to delete any existing one of the parameter items, which is unnecessary for an intended purpose, from the parameter information and to add any new one of the parameter items, which is necessary for the intended purpose, to the parameter information.

3. A three-dimensional modeling system as set forth in claim 2, wherein the computer portion makes it possible for the designer to delete all the parameter items that define a limited part of the three-dimensional model from the parameter information for making intermediate data of the parameter information and to add the new parameter items that newly define a modification of the limited part of the three-dimensional model to the intermediate data.

4. A three-dimensional modeling system as set forth in claim 1, wherein when the three-dimensional model is transmitted to another three-dimensional modeling system, the parameter items and the data are partly deleted to narrow a scope of the parameter information before transmitting the three-dimensional model in accordance with at least one of two necessities one of which is to use the three-dimensional model to be transmitted in a different application in the another three-dimensional model system and another of which is to make the three-dimensional model to be transmitted meet a different specification of the another three-dimensional model system.

5. A three-dimensional modeling system as set forth in claim 1, wherein the computer portion has a memory unit in which a parameter list showing the parameter items is registered in advance and any existing one of the parameter items is selectively deleted from the parameter list, while any new one of the parameter items is added to the parameter list.

6. A three-dimensional modeling system as set forth in claim 5, wherein, when a limited part of the three-dimensional model is designated by the designer, the computer portion displays the parameter list showing the parameter items only related to the limited part of the three-dimensional model by automatically discriminating the same from all the parameter items stored therein, so that the designer selects the parameter items necessary for an intended purpose among the discriminated parameter items shown in the parameter list.

7. A three-dimensional modeling system as set forth in claim 5, wherein the parameter list in which the new parameter items are added is newly registered in the memory unit.

8. A three-dimensional modeling system as set forth in claim 1, wherein the parameter items include at least one of a know-how for designing the three-dimensional model and a requisite for manufacturing the three-dimensional model.

9. A three-dimensional modeling system as set forth in claim 1, wherein the three-dimensional model is constituted by a combination of a plurality of components whose boundaries are defined by the respective parameter items and the data and, further, wherein the computer portion makes it possible that the designer edits the parameter items and the data by deleting any existing ones of the parameter items and the data corresponding thereto so as to once release the boundary of the existing components defined by the deleted parameter items and the corresponding data and adding any new ones of the parameter items and the data corresponding thereto that define new ones of the components, whose boundary is different from that of the existing components, to form the three-dimensional model same as the existing components.

10. A three-dimensional modeling system as set forth in claim 9, wherein the designer further adds any further new one of the parameter items and the data corresponding thereto that defines a new one of the components to form a modification of the three-dimensional model.

11. A method of designer's editing parameter items stored in a computer portion of a three-dimensional modeling system having a parametric function to change a shape of a three-dimensional model, comprising steps of:
designating a given part of the three-dimensional model so that the parameter items belonging to the given part of the three-dimensional model is displayed;
deleting any existing one of the parameter items; and
adding any new one of the parameter items.

12. A method of designer's editing the parameter items as set forth in claim 11, wherein the computer portion has a memory unit in which a parameter list showing the parameter items is registered in advance and, at a time of deleting and adding the parameter items, the parameter list is displayed so that the designer selectively deletes the existing parameter items unnecessary for an intended purpose among the parameter items shown in the parameter list and adds the new parameter items necessary for the intended purpose to the parameter list.

13. A memory media applicable to a computer portion of a three-dimensional modeling system having a parametric function to change a shape of a three-dimensional model by designer's editing parameter items, the memory media incorporating a computer program comprising steps of:
designating a given part of the three-dimensional model so that the parameter items belonging to the given part of the three-dimensional model is displayed;
deleting any existing one of the parameter items; and
adding any new one of the parameter items.

14. A memory media as set forth in claim 13, wherein the computer portion has a memory unit in which a parameter list showing the parameter items is registered in advance and, at a time of deleting and adding the parameter items, the parameter list is displayed so that the designer selectively deletes the existing parameter items unnecessary for an intended purpose among the parameter items shown in the parameter list and adds the new parameter items necessary for the intended purpose to the parameter list.
